(19) United States
(12) Patent Application Publication
(10) Pub. No.: US 2007/0060044 A1
(43) Pub. Date: Mar. 15, 2007

(54) Portable music system

(76) Inventors: Michael Lamb, San Diego, CA (US); George Seelman, Murrieta, CA (US); Jay Stone, San Marcos, CA (US)

Correspondence Address: PETER K HAHN;LUCE, FORWARD, HAMILTON, SCRIPPS, LLP., 600 WEST BROADWAY, SUITE 2600, SAN DIEGO, CA, 92101, US

(21) Appl. No.: 11/227,776

(22) Filed: Sep. 14, 2005

(51) Int. Cl. H04H 7/00

(52) U.S. Cl. 455/3.06

(57) ABSTRACT

The present invention provides a portable music system, comprising a remote control for transmitting signals over a wireless connection, an audio player for receiving the signals from the remote control, and conventional audio output wiring that is employed by a listener to listen to audio files that are stored on the audio player, wherein the conventional audio output wiring is further employed as an antenna for receiving the signals from the remote control.

### FIELD OF THE INVENTION

The present invention is directed to portable music systems, and more particularly to, a portable music system including a receiver that employs existing audio output wiring as an antenna for receiving signals from a wireless controller.

### BACKGROUND OF THE INVENTION

Portable digital audio players having large storage capacities (e.g., MP3 music players such as the IPOD audio player manufactured by Apple Computer of Cupertino, Calif.) allow a listener to carry an entire music collection. Such audio players are primarily used in conjunction with conventional headphones, but may also be used in conjunction with conventional speakers to serve as a home or office sound system. Some portable digital audio players include a wired remote control so that audio playback can be controlled while the main unit is safely hidden inside a pocket or bag.

MP3 music players typically include a FireWire connector for communicating with a computer to permit data transmissions to travel back and forth between the MP3 music player and the computer. In operation, MP3 music players are configured to play MP3 formatted songs that may be uploaded from the computer and stored in the MP3 player. The MP3 format is features compression of digital music to reduce the size of a digitized song without significantly affecting sound quality. As a result, listeners may download songs in minutes rather than hours.

One drawback of conventional digital audio players is that they were designed with pocket portability in mind, and do not include wireless remote control. Wired remote controls disadvantageously require the listener to be in close proximity to the audio player. Specifically, the range of the wired remote control is limited by the length of the wire linking the remote and the audio player. Another disadvantage of wired remote controls concerns the tendency of the wire(s) to become entangled and/or interfere with the listener's activities.

United States Patent Publication No. 2004/0171346 discloses a digital audio player featuring wireless control capability. Specifically, this publication teaches the use of a conventional antenna disposed on a remote control that is in wireless communication with another conventional antenna disposed on the digital audio player. One drawback of this system is that the audio player antenna is mounted to the audio player, and is therefore disposed in close proximity to the audio player, which is a source of noise and interference. An additional drawback is that the audio player antenna is limited by the dimensions of the audio player housing. A larger antenna would protrude from the audio player, thereby causing the system to be less comfortable, for example when disposed in the listener's pocket.

In view of the above, there exists a need for a portable music player comprising a transmitter (e.g., a remote control) for transmitting information over a wireless connection and a receiver (e.g., a portable digital audio player) that employs existing audio output wiring (such as headphone or speaker wires) as an antenna for receiving the information in the form of an occasional burst or a continuous feed.

There also exists a need for a portable music player including existing audio output wiring that serves the dual purpose of being used as conventional audio output wiring as well as an antenna for receiving signals.

Additionally, there exists a need for a portable music player including a remote control having improved range.

There also exists a need for a portable music player including an audio player having an antenna that is not limited by the dimensions of the audio player housing.

There further exists a need for a portable music player including an audio player having an antenna that reduces noise and interference from the audio player.

### SUMMARY OF THE INVENTION

In view of the foregoing, it is an object of the present invention to provide a portable music system for a hand-held music player, the system comprising a transmitter (e.g., a remote control) for transmitting information over a wireless connection and a receiver (e.g., a portable digital audio player) that employs existing audio output wiring as an antenna for receiving the information in the form of an occasional burst or a continuous feed.

It is another object of the invention to provide a portable music player including existing audio output wiring that serves the dual purpose of being used as conventional audio output wiring as well as an antenna for receiving signals.

It is an additional object of the invention to provide a portable music player that provides greater range for the remote control device.

It is another object of the invention to provide a portable music player including an audio player having an antenna that is not limited by the dimensions of the audio player housing.

It is yet another object of the invention to provide a need for a portable music player including an audio player having an antenna that reduces noise and interference from the audio player.

The present invention is directed to a wireless remote control for an IPOD (manufactured by Apple Computers, Inc., Cupertino, Calif.) or similar device, the portable music system comprising a receiver such as a portable digital audio player that employs existing audio output wiring as an antenna for receiving signals from a wireless controller. For example, the existing audio output wiring may comprise headphone wires, speaker wires or other conventional forms of audio output wiring. According to an aspect of the invention, the existing audio output wiring serves the dual purpose of being used as conventional audio output wiring as well as an antenna for receiving signals. The use of the headphones as an antenna significantly increases the range of the wireless controller, in part due to the increased distance of the headphone wire(s) from the audio player. In particular, since the distal portion of the headphone wires are disposed at a considerable distance from the audio player, the noise and interference caused by the audio player are reduced, thereby increasing the range of the associated remote control device.

According to a preferred implementation of the invention, electrical circuitry is employed to couple 433 MHz radio frequency signals from the audio cable to the receiver, but not to the audio circuitry. Likewise, the electrical circuitry is employed to couple the audio signals from the audio player to the audio cable, but not to the receiver.

One aspect of the present invention involves a portable music system, comprising a remote control for transmitting signals over a wireless connection, an audio player for receiving the signals from the remote control, and a set of headphones connected to the audio player by electrical wires. The headphones are worn by a listener for listening to audio files that are stored on the audio player. The headphones include one or more electrical headphone wires that are employed as an antenna for receiving the signals from the remote control. The remote control includes a plurality of buttons for controlling the functionality of the audio player from a remote location. According to a preferred implementation of the invention, the audio player comprises an MP3 music player capable of storing and selectively playing thousands of CD-quality songs.

Another aspect of the present invention involves the use of the headphone wires as an antenna to significantly increase the range of the remote control. Specifically, the range of the remote control is increased because a distal portion of the headphone wires is disposed at a significant distance from the audio player during operation of the portable music system, thereby limiting the amount of noise and interference caused by the audio player and increasing the range of the remote control.

According to a further aspect of the invention, the audio player comprises a receiver for receiving radio frequency signals from the remote control and audio circuitry for transmitting audio signals through the headphones in the form of music. The radio frequency signals from the remote control are coupled to the receiver, but are not coupled the audio circuitry, whereas the audio signals from the audio player are coupled to the headphone wires, but are blocked with respect to the receiver. According to some embodiments of the invention, the audio player includes a receiver and a filter that passes selected signals to the receiver, but blocks signals that differ in frequency by at least a predetermined amount. In other words, the headphone wires function simultaneously as both an antenna and an audio signal carrier.

An additional aspect of the present invention involves a portable music system, comprising a remote control for transmitting signals over a wireless connection, an audio player for receiving the signals from the remote control, and a speaker assembly connected to the audio player by electrical wires. The speaker assembly includes one or more electrical speaker wires that are employed as an antenna for receiving the signals from the remote control. The audio player comprises an MP3 music player capable of storing and selectively playing thousands of CD-quality songs.

Similar to the headphone wires, the use of the speaker wires as an antenna significantly increases the range of the remote control because a distal portion of the speaker wires is disposed at a significant distance from the audio player during operation of the portable music system, thereby limiting the amount of noise and interference caused by the audio player. The audio player comprises a receiver for receiving radio frequency signals from the remote control and audio circuitry for transmitting audio signals through the speaker assembly in the form of music. The radio frequency signals from the remote control are coupled to the receiver, but are not coupled the audio circuitry, whereas the audio signals from the audio player are coupled to the speaker wires, but are blocked with respect to the receiver.

### BRIEF DESCRIPTION OF THE DRAWINGS

FIG. 1 illustrates a preferred portable music system in accordance with the principles of the present invention;

FIG. 2 is a diagram illustrating the electrical circuitry of the audio player of the present invention;

FIGS. 3 and 4 are schematic diagrams depicting the electrical circuitry of the audio player of the present invention;

FIG. 5 is a perspective view of the audio player of the present invention;

FIG. 6 is a perspective view of the audio player and docking station of the present invention;

FIG. 7 is a perspective view of the audio player and docking station of FIG. 6, wherein the docking station is hard wired to a computer; and

FIG. 8 illustrates an alternative portable music system in accordance with the principles of the present invention.

### DETAILED DESCRIPTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

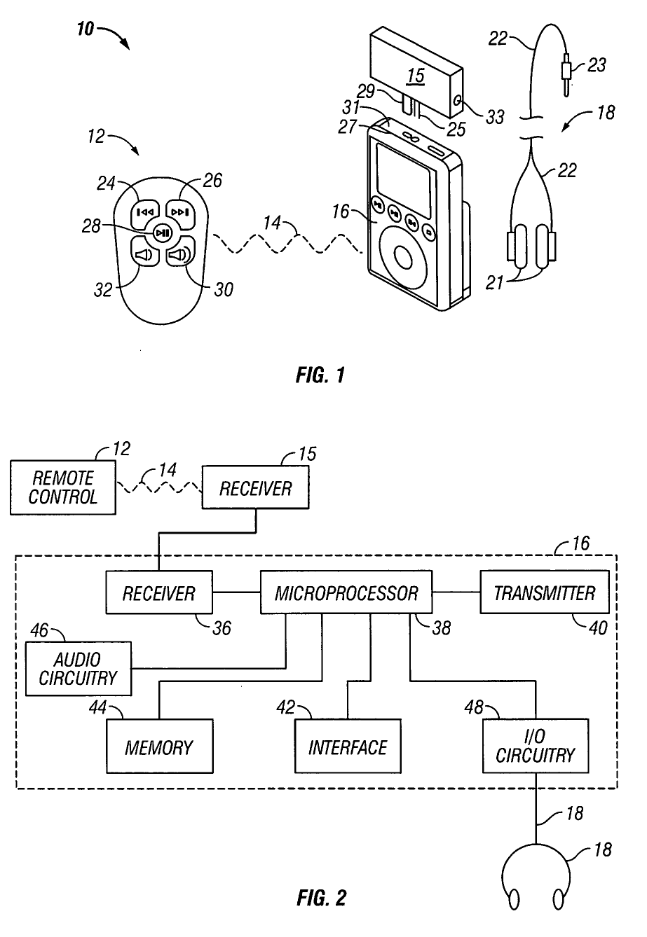

FIG. 1 depicts a preferred portable music system 10 of the present invention, the system comprising a remote control 12 for transmitting information over wireless connection 14, a plug-in receiver 15 for receiving and processing wireless information from remote control 12, an audio player 16 and conventional audio output wiring 18. Receiver 15 includes stereo audio plug 25 for insertion into conventional audio jack 27, connector plug 29 for insertion into remote jack 31 of audio player 16, and audio output jack 33 for receiving stereo audio plug 23. In the illustrated embodiment, conventional audio output wiring 18 comprises a set of headphones 21 configured to be wired to plug-in receiver 15 using electrical wires 22 and stereo audio plug 23. According to other embodiments of the invention, conventional audio output wiring 18 may comprise speaker wires, microphone wires or amplifier wires.

In operation, a listener may employ the conventional audio output wiring to play music stored on the audio player, for example while working out at the gym. Remote control 12 preferably comprises a wireless device including buttons 24, 26, 28, 30, 32 for controlling the functionality of the audio player from a remote location. For example, the buttons may comprise reverse seek button 24, forward seek button 26, play/pause button 28, volume up button 30, and volume down button 32. As would be understood by those of ordinary skill in the art, additional and/or different buttons may be provided for operating audio player 16 without departing from the scope of the present invention.

In the preferred embodiment, audio player 16 comprises an audio player such as an MP3 music player (e.g., an IPOD MP3 player manufactured by Apple Computer of Cupertino, Calif.). When receiver 15 is plugged into audio player 16, receiver 15 is able to draw power from the remote jack 31 such that separate powering of the base station is unnecessary. Plug-in receiver 15 comprises electrical circuitry for receiving and processing input (e.g., radio frequency signals) received from remote control 12, and for sending instructions to the audio player. Audio player 16 includes electrical circuitry for receiving input from receiver 15, as well as electrical circuitry for playing music files that are stored on the audio player. The audio player is a handheld device dimensioned to fit within a pocket such that the listener's hands are free. The listener may use the audio player to store and selectively play thousands of CD-quality songs.

In accordance with an aspect of the present invention, conventional audio output wiring 18 serves a dual purpose. Particularly, audio output wiring 18 is used in a conventional manner such as providing electrical communication between the audio player and a pair of headphones 21 or between the audio player and one or more speakers. Additionally, conventional audio output wiring 18 is employed as an antenna for receiving signals from remote control 12. Specifically, audio output wiring 18 is configured to act as an antenna for receiving radio frequency signals from remote control 12. During operation of the audio player, the use of the audio output wiring as an antenna significantly increases the range of remote control 12. One reason for the increased range is that a distal portion of audio output wiring is disposed at a significant distance from the audio player during operation, thereby limiting the amount of noise and interference caused by the audio player and increasing the range of remote control 12.

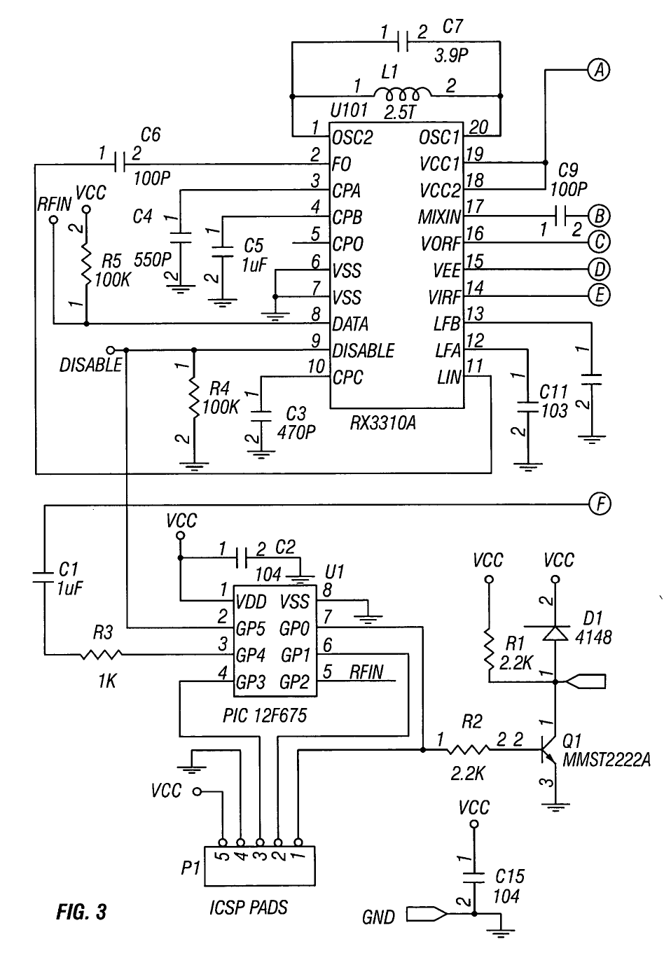

FIG. 2 is a diagram illustrating the electrical circuitry of the embodiment of FIG. 1. Specifically, remote control 12 transmits signals (e.g., radio frequency signals) to plug-in receiver 15 over wireless connection 14. Audio player 16 comprises a receiver 36 for receiving remote control signals from receiver 15, microprocessor 38, transmitter 40 for transmitting audio frequency signals, interface 42, memory 44, audio circuitry 46, and input/output support circuitry 48 for controlling audio output through headphones 18. Conventional audio output wiring 18 including headphones and speakers may be connected to input/output support circuitry 48 using appropriate connectors and jacks. In accordance with the preferred implementation of the invention, the electrical circuitry couples the remote control signals from conventional audio output wiring 18 to receiver 38, but does not couple the remote control signals to audio circuitry 46. Additionally, the electrical circuitry is employed to couple the audio signals from audio player 16 to conventional audio output wiring 18, yet block these signals with respect to receiver 38.

In operation, remote control 12 sends signals over wireless connection 14 to plug-in receiver 15 when one of the remote control buttons 24, 26, 28, 30, 32 is depressed. Plug-in receiver 15 transfers the remote control signals to audio player 16 through connector plug 29. Once audio player 16 receives the signals, microprocessor 36 converts the signals to the appropriate wired remote commands native to audio player 16. Advantageously, the listeners may wirelessly control audio player using the same commands available to a wired remote of audio player. Although the preferred type of wireless connection is achieved using radio frequency signaling, other forms of wireless signaling such as ultrasonic signaling and infrared signaling may be employed without departing from the scope of the invention.

According to an alternative embodiment of the invention, audio player 16 is provided with electrical circuitry for receiving signals directly over the wireless connection from remote control 12 such that plug-in receiver 15 is unnecessary. According to this embodiment, the conventional audio output wiring is plugged directly into conventional audio jack 27 of audio player 16 rather than being plugged into audio output jack 33 of plug-in receiver 15.

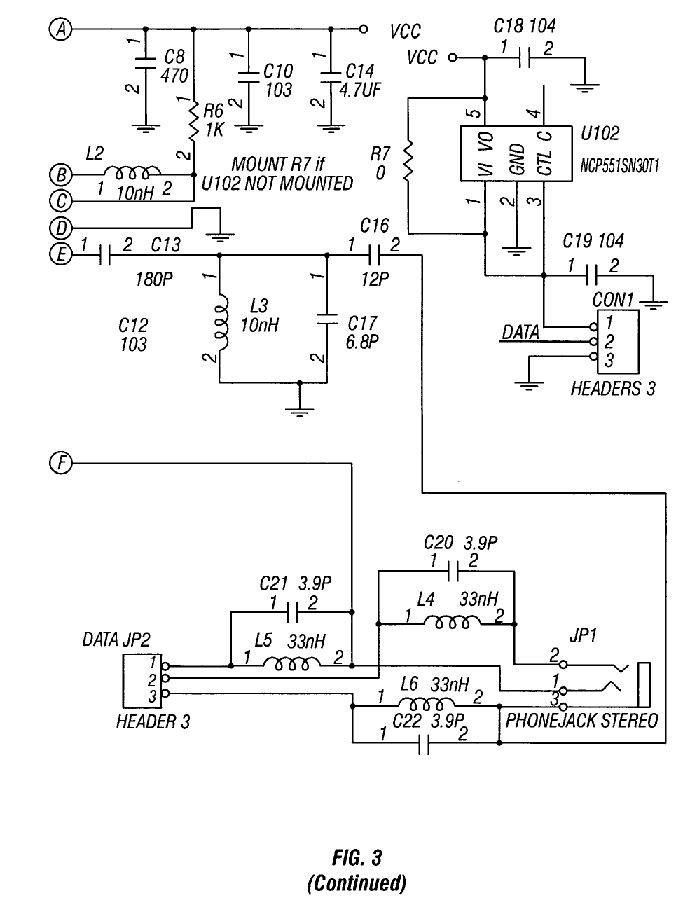

FIGS. 3 and 4 are schematic diagrams depicting the electrical circuitry of the audio player of the present invention. Radio frequency signals from remote control 12 are picked up by conventional audio output wiring 18 (i.e., the antenna) such that the signals enter on pin 3 of JP 1. At approximately 433 MHz, the reactances of L6 and C22 are approximately equal in magnitude. In the illustrated embodiment, the reactances of L6 and C22 are about 90 ohms and 94 ohms, respectfully. At this frequency, the parallel combination of L6 and C22 appears as a high impedance of about 2000 ohms. Advantageously, the high impedance isolates the antenna from JP2 and the audio circuitry at about MHz, yet passes other audio frequencies with minimal attenuation.

The conductors in the audio cable that connect to pins 1 and 2 of JP 1 are disposed in close proximity, and are capacatively coupled to the conductor that connects to pin 3. Pins 1 and 2 are isolated by C21, L5 and C20 in a similar manner as described hereinabove. L4, C16, C17, L3 and C 13 make up a matching network and band pass filter. The matching network and band pass filter passes the 433 MHz signal of interest to the receiver IC, UlOl, but blocks signals that differ in frequency by at least a predetermined amount. The blocked signals include the audio frequency signals coming from the audio player via JP2. Advantageously, the above-described electrical circuitry permits conventional audio output wiring 18 to function simultaneously as both an antenna (e.g., at approximately 433 MHz) and an audio signal carrier.

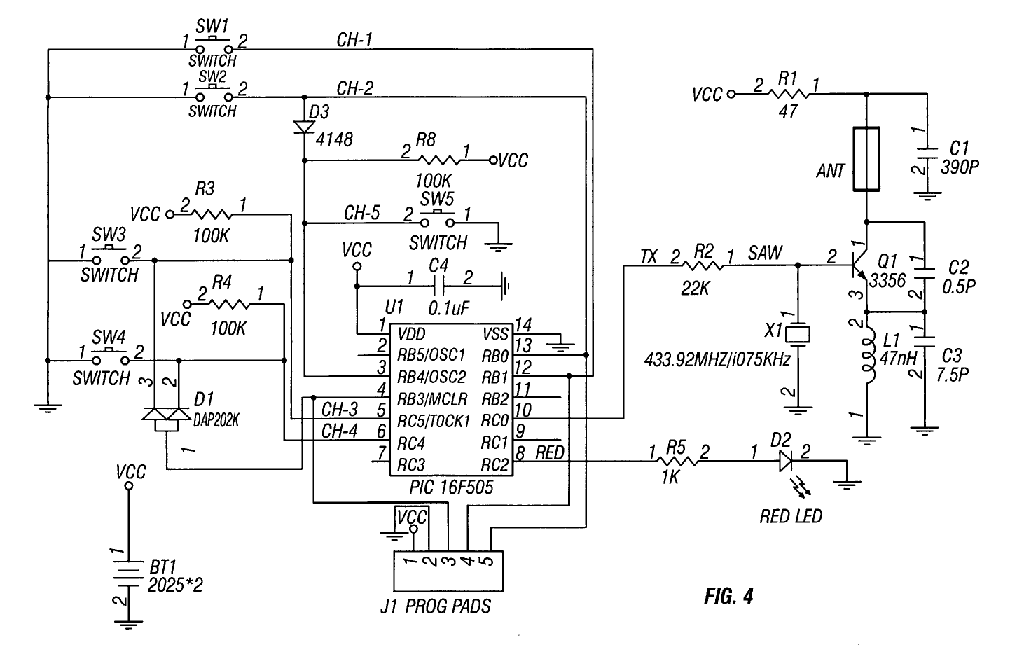

Referring to FIG. 5, audio player 16 comprises housing 50 that encloses electrical circuitry for operating the audio player, interface 54 that allows the listener to store and play music, and display screen 58 (e.g., an LCD) for displaying a graphical interface including objects, text and graphics. The electrical circuitry may comprise components such as: microprocessors; circuit boards; hard drives; memories (e.g., RAM, ROM, Flash); input/output circuitry; and/or batteries. The electrical components may also comprise other devices for inputting or outputting music such as: headphones; speakers; microphones; amplifiers and/or digital signal processors. Additionally, the electrical components may include devices for sending and receiving media such as: antennae; transmitters; receivers; and/or transceivers. Audio player 16 preferably includes a hard drive providing massive storage capacity for hundreds of hours of music. Hard drive capacity may vary from 5 MB to over 20 MB. The audio player may further include a conventional battery such as a rechargeable lithium polymer battery that provides 10 or more hours of continuous playtime for the audio player.

Interface 54 provides the listener with buttons, switches, and touch pads for controlling audio player functionality. Specifically, touch pad 62 allows the listener to interact with the audio player with one or more fingers. Touch pad 62 provides one or more control functions for making selections associated with operating the audio player. Interface 54 further comprises buttons 66, 68, 70, 72 provide dedicated control functions for making selections associated with operating audio player 16. In the illustrated embodiment, the buttons include play/pause button 66, forward seek button 68, reverse seek button 70, and stop button 72. Interface 54 may also include song information button 76 for displaying information pertaining to the song such as the singer name and album.

Audio player 16 further includes hold switch 82 used to activate or deactivate the buttons and touch pad, and data port 86. The deactivation mode is selected to prevent unwanted commands, for example while being stored inside the listener's pocket. Data port 86 is capable of receiving a data plug for transmitting and receiving data to and from a host device such as a computer. Data port 86 may be used to upload or down load audio information such as songs to and from the audio player. The data port may comprise a power port, a serial port, a parallel port, a PS/2 port, a USB port, a Firewire port or combinations thereof.

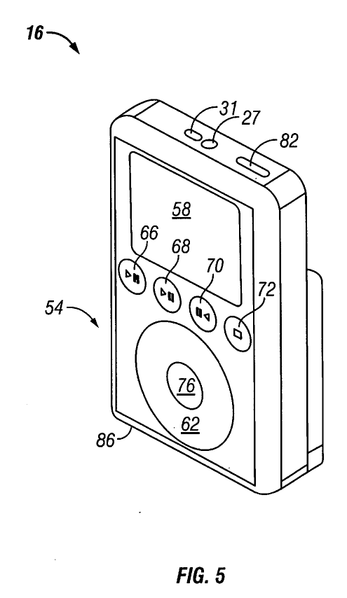

Referring to FIG. 6, audio player 16 may be releasably mounted to docking station 92 to allow communication with other media devices such as including computers, personal digital assistants and storage devices. Specifically, docking station 92 includes a housing 93 that encloses electrical circuitry and defines a substantially rectangular shape, and an opening 94 for receiving a lower portion 96 of audio player 16. According to some embodiments of the invention, opening 94 is sloped such that audio player 16 is tilted with respect to docking station 92 when it is positioned within opening 94. Connector 98 is provided within opening 94 for engaging a corresponding connector (not shown) disposed on the bottom surface of audio player 16. In the illustrated embodiment, connector 98 comprises a male plug, whereas the audio player connector (not shown) comprises a female port.

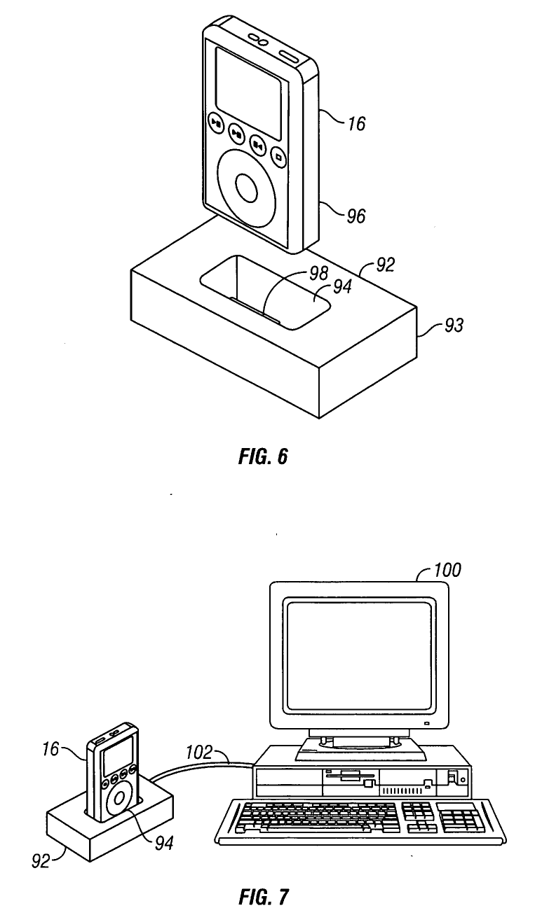

Referring to FIG. 7, in accordance with an exemplary embodiment of the invention, audio player 16 is shown mounted to docking station 92, which is hard wired to computer 100. In particular, docking station 250 is operatively coupled to computer 100 via electrical wires 102 such that one end of wires 102 is in electrical communication with docking station 92, and the other end of the wires is in electrical communication with computer 100. The illustrated embodiment permits communication between audio player 16 and computer 100 such that music files may be passed there between. More particularly, the listener may use the audio player interface to upload and download songs between audio player 16 and computer 100 via docking station 92.

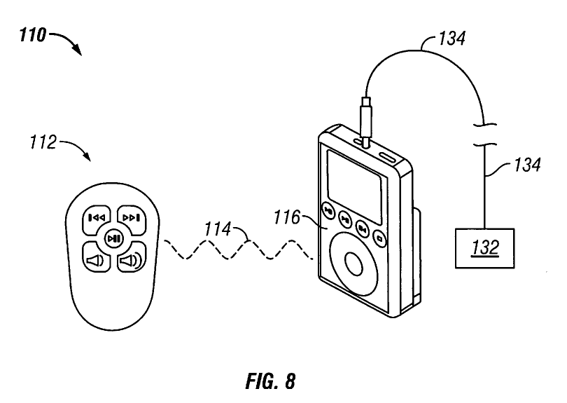

Referring to FIG. 8, according to an alternative embodiment of the invention, portable music player 110 comprises remote control 112 for transmitting information over wireless connection 114, audio player 116 for receiving information from remote control 112, and conventional audio output wiring 118 comprising speaker assembly 132 wired to audio player 116 via electrical wires 134. Similar to the previous embodiment, audio player 116 comprises an audio player such as an MP3 music player and remote control 112 comprises a wireless remote control device for controlling the functionality of the audio player. Speaker assembly 132 comprises one or more conventional speakers that are employed to output music as part of a home or office sound system provided by portable music player 130.

In accordance with another aspect of the invention, speaker assembly 132 acts as conventional speakers and as an antenna for receiving signals from remote control 112. More particularly, speaker wires 134 are configured to act as an antenna for receiving information from remote control 112 as a continuous feed. During operation of the music player, the use of the speaker wires as an antenna significantly increases the range of remote control 112. One reason for the increased range is that a portion of speaker wires 134 are disposed at a significant distance from the audio player during operation, thereby limiting the amount of noise and interference caused by the audio player and increasing the range of remote control 112.

Thus, it is seen that a portable music system including a receiver that employs conventional audio output wiring as an antenna for receiving signals from a wireless controller is provided. One skilled in the art will appreciate that the present invention can be practiced by other than the various embodiments and preferred embodiments, which are presented in this description for purposes of illustration and not of limitation, and the present invention is limited only by the claims that follow. It is noted that equivalents for the particular embodiments discussed in this description may practice the invention as well.

What is claimed is:

1. A portable music system, comprising:
a remote control for transmitting signals over a wireless connection;
an audio player for receiving the signals from the remote control; and
conventional audio output wiring connected to the audio player;
wherein the conventional audio output wiring is employed by a listener to listen to audio files that are stored on the audio player;
wherein the conventional audio output wiring is employed as an antenna for receiving the signals from the remote control.

2. The portable music system of claim 1, further comprising a plug-in receiver for receiving the signals from the remote control and for sending instructions to the audio player.

3. The portable music system of claim 2, wherein the plug-in receiver includes an audio output jack for receiving a stereo audio plug.

4. The portable music system of claim 1, wherein the remote control includes a plurality of buttons for controlling the functionality of the audio player from a remote location.

5. The portable music system of claim 1, wherein the audio player comprises an MP3 music player.

6. The portable music system of claim 1, wherein the audio player is a handheld device capable of storing and selectively playing thousands of CD-quality songs.

7. The portable music system of claim 1, wherein the use of the conventional audio output wiring as an antenna significantly increases the range of the remote control.

8. The portable music system of claim 7, wherein the range of the remote control is increased because a distal portion of the conventional audio output wiring is disposed at a significant distance from the audio player during operation of the portable music system, thereby limiting the amount of noise and interference caused by the audio player and increasing the range of the remote control.

9. The portable music system of claim 1, wherein the audio player comprises a receiver for receiving audio frequency signals from the remote control and a transmitter for transmitting audio frequency signals to the conventional audio output wiring.

10. The portable music system of claim 1, wherein the audio player comprises a receiver for receiving radio frequency signals from the remote control and audio circuitry for transmitting audio signals through the conventional audio output wiring in the form of music.

11. The portable music system of claim 10, wherein the radio frequency signals from the remote control are coupled to the receiver, but are not coupled the audio circuitry.

12. The portable music system of claim 10, wherein audio signals from the audio player are coupled to the conventional audio output wiring, but are blocked with respect to the receiver.

13. The portable music system of claim 1, wherein the audio player includes a receiver and a filter that passes selected signals to the receiver, but blocks signals that differ in frequency by at least a predetermined amount.

14. The portable music system of claim 1, wherein the conventional audio output wiring functions simultaneously as both an antenna and as an audio signal carrier.

15. The portable music system of claim 1, wherein the conventional audio output wiring comprises one or more headphone wires.

16. The portable music system of claim 1, wherein the conventional audio output wiring comprises one or more speaker wires.

17. The portable music system of claim 1, wherein the conventional audio output wiring comprises an audio jack.

18. The portable music system of claim 1, wherein the conventional audio output wiring comprises one or more amplifier wires.
